(19) United States
(12) Patent Application Publication
(10) Pub. No.: US 2002/0145126 A1
(43) Pub. Date: Oct. 10, 2002

(54) Ball valve

(76) Inventor: Bing-Tson Lian, Chang Hua Hsien (TW)

Correspondence Address: HARRISON & EGBERT, 1018 Preston St., Suite 100, Houston, TX, 77002, US

(21) Appl. No.: 09/828,666

(22) Filed: Apr. 9, 2001

(51) Int. Cl. F16K 5/06

(52) U.S. Cl. 251/315.14

(57) ABSTRACT

A ball valve comprises a tubular body in which a spherical body is rotatably disposed such that the spherical body is connected with a control rod via a connection portion of the tubular body. The spherical body is provided in the outer wall with a retaining slot. The control rod is provided at one end with a retaining body, which is retained in the retaining slot of the spherical body.

### BACKGROUND OF THE INVENTION

1. Field of the Invention

The present invention relates generally to a ball valve, and more particularly to a spherical body and a control rod of the ball valve.

2. Description of Related Art

As shown in FIG. 1, a ball valve 10 of the prior art comprises a tubular body 11 which is provided with a fitting projection 12 having a hollow interior in communication with the hollow interior of the tubular body 11. The fitting projection 12 is provided at the top end with a cut 13. A rotary knob 16 is provided at one end with a connection protrusion 17 which is fitted into the hollow interior of the fitting projection 12 such that a protruded block 19 of the rotary knob 16 is rotatably confined in the cut 13 of the fitting projection 12. A spherical body 14 is provided with a connection rod 15. The spherical body 14 is located in the hollow interior of the tubular body 11 such that the connection rod 15 is fastened with the connected protrusion 17 of the rotary knob 16 by a fastening screw 18.

The prior art ball valve 10 is defective in design in that the assembly of the spherical body 14 and the rotary knob 16 can not be done with ease and speed, and that the fastening screw 18 is incapable of holding the connection rod 15 of the spherical body 14 and the connection protrusion 17 of the rotary knob 16 securely together for a prolonged period of time.

### BRIEF SUMMARY OF THE INVENTION

The primary objective of the present invention is to provide a ball valve which is free of the deficiencies of the prior art ball valve described above.

In keeping with the principle of the present invention, the foregoing objective of the present invention is attained by a ball valve comprising a tubular body in which a spherical body is rotatably disposed such that the spherical body is joined with a control rod of the ball valve. The spherical body is provided in the outer surface with a retaining slot, whereas the control rod is provided at one end with a retaining body which is retained in the retaining slot of the spherical body.

The features and functions of the present invention will be more readily understood upon a thoughtful deliberation of the following detailed description of a preferred embodiment of the present invention in reference to the accompanying drawings.

### BRIEF DESCRIPTION OF THE SEVERAL VIEWS OF THE DRAWINGS

FIG. 1 shows an exploded view of a ball valve of the prior art.

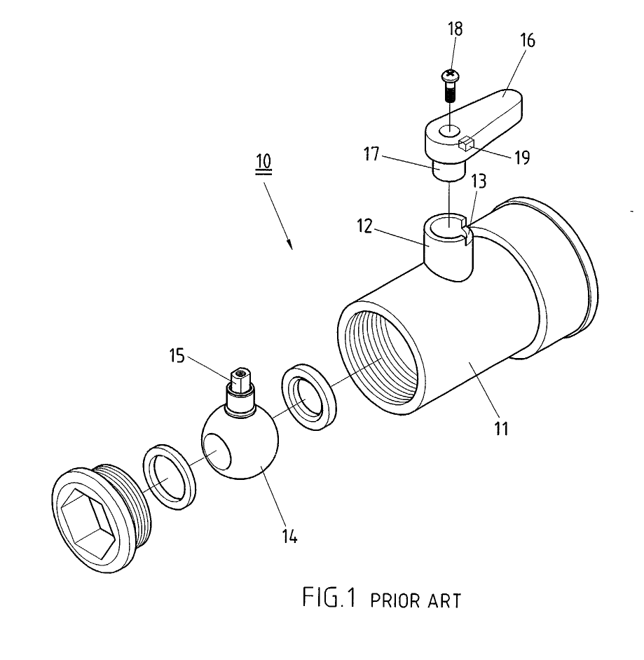

FIG. 2 shows a perspective view of a ball valve of the preferred embodiment of the present invention.

FIG. 3 shows an exploded view of the ball valve of the preferred embodiment of the present invention.

FIG. 4 shows a longitudinal sectional view of the ball valve of the preferred embodiment of the present invention at work.

FIG. 5 shows another longitudinal sectional view of the ball valve of the preferred embodiment of the present invention at work.

### DETAILED DESCRIPTION OF THE INVENTION

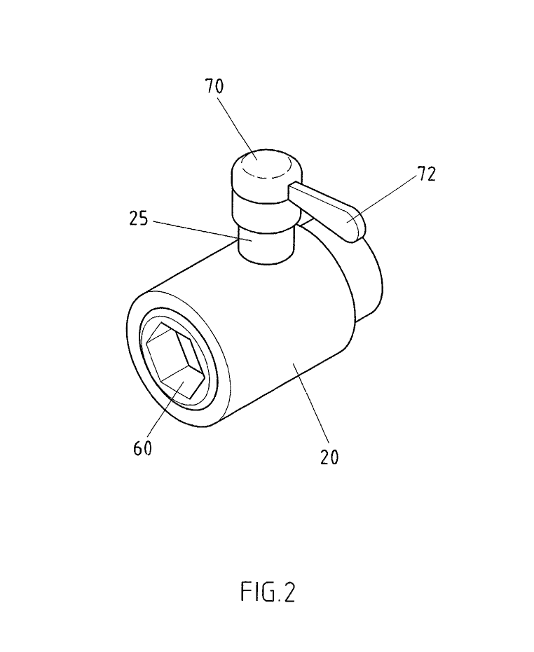

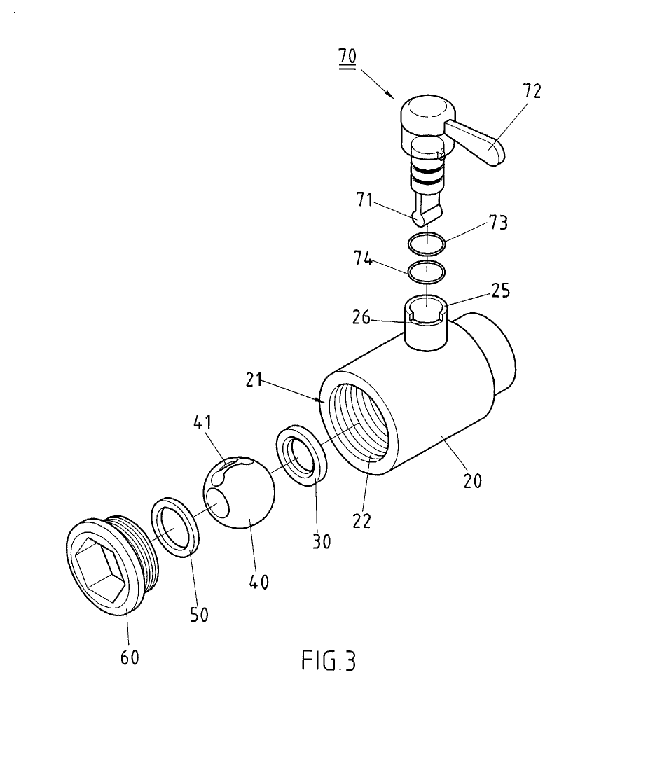

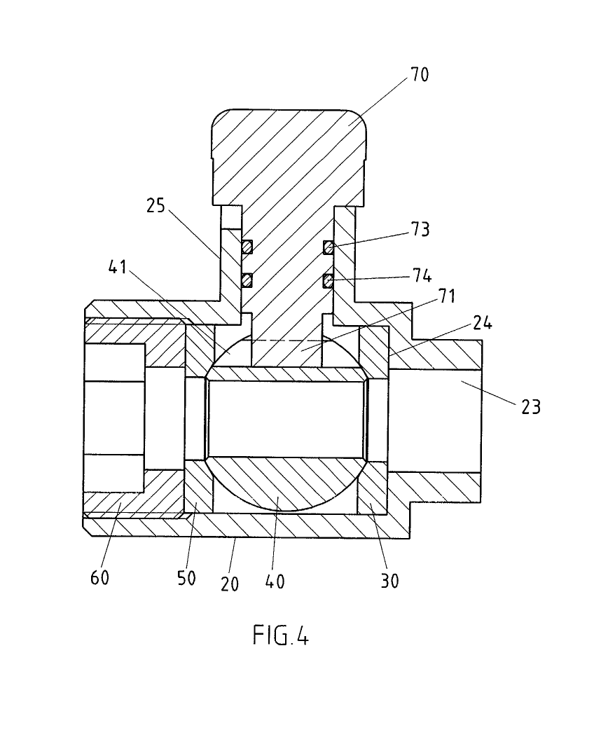

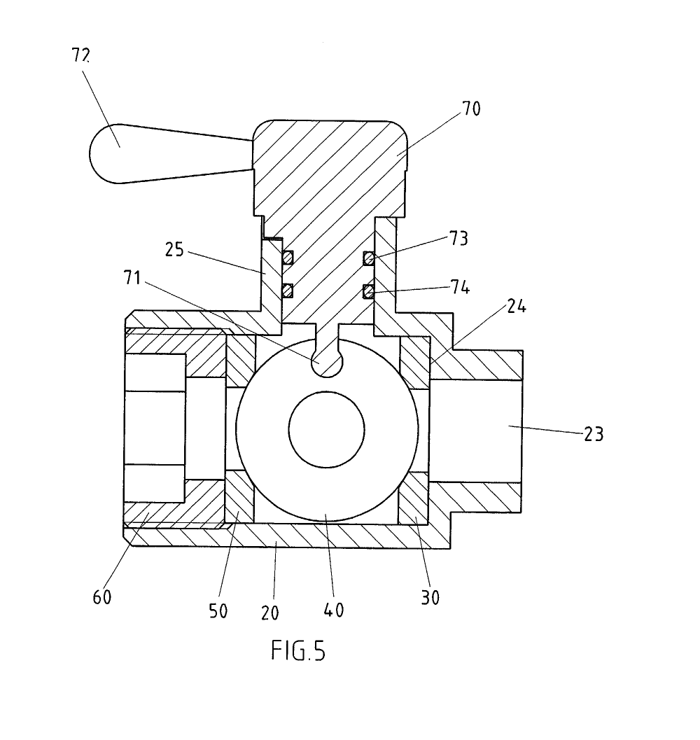

As shown in FIGS. 2-5, a ball valve embodied in the present invention is formed of a tubular body 20, a spherical body 40, a nut 60, and a control rod 70.

The tubular body 20 has a through hollow interior which is provided at one end with a first opening 21, and at other end with a second opening 23. The first opening 21 is provided with a plurality of inner threads 22. The second opening 23 is smaller in diameter than the first opening 21 and is provided in the inner wall with an annular stop portion 24. The tubular body 20 is further provided in the outer wall with a tubular connection portion 25 extending uprightly therefrom. The tubular connection portion 25 has a through hollow interior perpendicular to and in communication with the through hollow interior of the tubular body 20. The tubular connection portion 25 is provided at the top end with a cut 26.

The spherical body 40 is provided with a through hollow interior in alignment with the through hollow interior of the tubular body 20 and is further provided in the outer wall with a retaining slot 41.

The nut 60 is provided at one end with outer threads engageable with the inner threads 22 of the first opening 21 of the tubular body 20.

The control rod 70 is provided at one end with a retaining body 71, and at other end with a handle 72.

In combination, the spherical body 40 is rotatably located in the hollow interior of the tubular body 20 in conjunction with two washers 30 and 50, as well as the nut 60 which is fastened with the first opening 21 of the tubular body 20. The control rod 70 is joined with the spherical body 40 via the tubular connection portion 25 of the tubular body 20 in conjunction with two washers 73 and 74 such that the retaining body 71 of the control rod 70 is retained in the retaining slot 41 of the spherical body 40. The retaining slot 41 of the spherical body 40 is similar in cross-sectional shape to the retaining body 71 of the control rod 70.

Unlike the prior art ball valve, the assembly of the spherical body 40 and the control rod 70 can be done with ease and speed. The spherical body 40 of the present invention can be easily put into the hollow interior of the tubular body 20. In addition, the connection of the spherical body 40 with the control rod 70 is attained without the use of the fastening screw.

The embodiment of the present invention described above is to be regarded in all respects as being merely illustrative and not restrictive. Accordingly, the present invention may be embodied in other specific forms without deviating from the spirit thereof. The present invention is therefore to be limited only by the scope of the following claim.

I claim:

1. A ball valve comprising:
a tubular body having a through hollow interior, said tubular body provided at one end of said through hollow interior with inner threads and at other end of said through hollow interior with an annular stop portion, said tubular body further provided in an outer wall with a tubular connection portion extending therefrom and having a through hollow interior perpendicular to and in communication with said through hollow interior of said tubular body;
a spherical body having a through hollow interior in alignment with said through hollow interior of said tubular body, said spherical body being rotatably located in said through hollow interior of said tubular body in conjunction with a plurality of washers;
a nut provided at one end with outer threads and fastened with said tubular body such that the outer threads of said nut are engaged with the inner threads of said tubular body; and
a control rod fastened at one end with said spherical body via said tubular connection portion of said tubular body, said control rod being provided at other end with a handle fastened therewith;
wherein said spherical body is provided in an outer wall with a retaining slot; and wherein said one end of said control rod is provided with a retaining body whereby said control rod is fastened with said spherical body such that said retaining body of said control rod is retained in said retaining slot of said spherical body.
